(19) United States
(12) Patent Application Publication
(10) Pub. No.: US 2026/0106471 A1
(43) Pub. Date: Apr. 16, 2026

(54) SEMICONDUCTOR DEVICE

(71) Applicants: Yuichi UEDA, Tokyo (JP); Junji TAKESHITA, Tokyo (JP)

(72) Inventors: Yuichi UEDA, Tokyo (JP); Junji TAKESHITA, Tokyo (JP)

(73) Assignee: MITSUMI ELECTRIC CO., LTD., Tokyo (JP)

(21) Appl. No.: 19/350,492

(22) Filed: Oct. 6, 2025

(30) Foreign Application Priority Data
Oct. 15, 2024 (JP) 2024-179678

(51) Int. Cl. H02J 7/00

(52) U.S. Cl. CPC H02J 7/64; H02J 7/865

(57) ABSTRACT

To protect an integrated circuit from abnormally high voltage applied to an external terminal in a semiconductor device mounted with an integrated circuit for controlling charge/discharge of a secondary battery, the semiconductor device includes: first external terminal connected to secondary battery; second external terminal electrically connected to first external terminal and configured to output voltage received from secondary battery to outside; third external terminal configured to be entered or output a signal from/to outside; first integrated circuit configured to control charge/discharge of secondary battery and including first signal terminal configured to be entered or output a signal; and second integrated circuit, the second integrated circuit including: second signal terminal connected to third external terminal; third signal terminal connected to first signal terminal; first switch positioned between second signal terminal and third signal terminal; and anti-overvoltage protection circuit configured to shut OFF first switch when detecting overvoltage of second signal terminal.

### CROSS-REFERENCE TO RELATED APPLICATION

The present application claims priority under 35 U.S.C. § 119 to Japanese Patent Application No. 2024-179678, filed Oct. 15, 2024, the contents of which are incorporated herein by reference in their entireties.

### BACKGROUND OF THE INVENTION

### Field of the Invention

The present disclosure relates to a semiconductor device.

### Description of the Related Art

A battery pack mounted with a secondary battery capable of supplying electric power to a portable electronic device or the like and a control IC (Integrated Circuit) for controlling charge/discharge of the secondary battery is known. For example, the control IC includes a communication unit for communicating data with a charger connected to the battery pack, and transmits the required values of the charging voltage and charging current of the secondary battery to the charger via an external terminal (for example, Japanese Patent Application Laid-Open Publication No. 2008-27826).

### SUMMARY OF THE INVENTION

For example, when connecting a terminal of an external device, such as a charger, an electronic device, and the like, to the external terminal of this type of a battery pack, there may be a case where an abnormally high voltage is applied to the external terminal of the battery pack. The application of the abnormally high voltage may damage the control IC. However, no technique for protecting the control IC from the abnormally high voltage applied to the external terminal has been proposed, and this needs to be cured. When additionally providing the battery pack with a protection circuit for protecting the control IC from the abnormally high voltage, it is preferable to restrict the power consumption of the battery pack that would increase due to the addition of the protection circuit.

An object of the disclosed technique is to protect an integrated circuit from an abnormally high voltage applied to an external terminal in a semiconductor device mounted with an integrated circuit for controlling charge/discharge of a secondary battery.

In order to solve the above technical problem, a semiconductor device according to one embodiment of the present disclosure includes:
a first external terminal connected to a secondary battery;
a second external terminal electrically connected to the first external terminal and configured to output a voltage received from the secondary battery to outside;
a third external terminal configured to be entered by a signal from or output a signal to outside;
a first integrated circuit configured to control charge/discharge of the secondary battery and including a first signal terminal configured to be entered by or output a signal; and
a second integrated circuit, the second integrated circuit including: a second signal terminal connected to the third external terminal; a third signal terminal connected to the first signal terminal; a first switch positioned between the second signal terminal and the third signal terminal; and an anti-overvoltage protection circuit configured to shut OFF the first switch when detecting an overvoltage of the second signal terminal.

It is possible t to protect an integrated circuit from an abnormally high voltage applied to an external terminal in a semiconductor device mounted with an integrated circuit for controlling charge/discharge of a secondary battery.

### BRIEF DESCRIPTION OF THE DRAWINGS

FIG. 1 is an example of a block diagram showing an embodiment of a semiconductor device according to the present disclosure; and

FIG. 2 is a state transition diagram showing an example of operation mode transition of a protection IC by a mode control circuit of FIG. 1.

### DETAILED DESCRIPTION OF THE DISCLOSURE

The embodiments will be described below with reference to the drawings. In the following description, the same reference numerals as those of signal names may be used for signal lines, signal terminals, and signal nodes to which the signals are transmitted. The same reference numerals as those of voltage names may be used for voltage lines, voltage terminals, and voltage nodes to which the voltages are supplied. In the drawings, the same reference numerals may be used for the same components, and duplicate descriptions may be omitted.

### Example of Semiconductor Device of One Embodiment

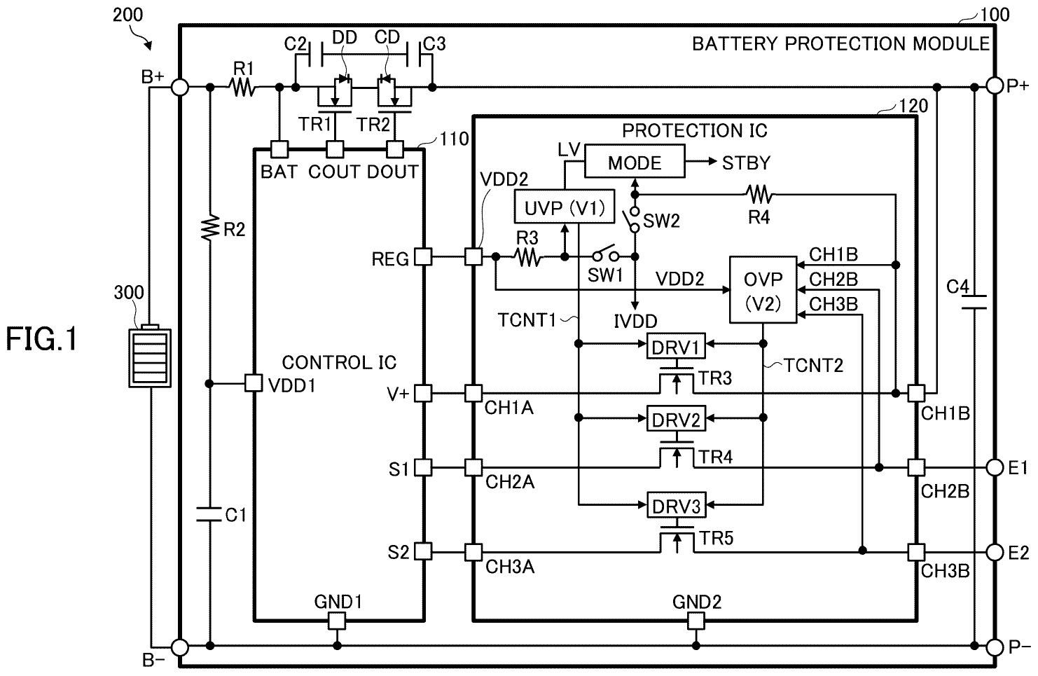

FIG. 1 is an example of a block diagram showing an embodiment of a semiconductor device according to the present disclosure. For example, a battery protection module 100 shown in FIG. 1 is mounted on a battery pack 200 together with a secondary battery 300, such as an Li-ion battery and the like. The battery protection module 100 includes a control IC 110, a protection IC 120, transistors TR1 and TR2, resistors R1 and R2, and capacitors C1, C2, C3, and C4.

In FIG. 1, external terminals of the battery protection module 100 are represented by circles, and internal terminals of the battery protection module 100 are represented by squares. For example, the external terminals of the battery protection module 100 are terminals provided in a connector to which the secondary battery 300 is connected and in connectors to which an electronic device or a charger is connected.

The internal terminals serve also as external terminals of the control IC 110 and the protection IC 120. The battery protection module 100 is an example of a semiconductor device. The control IC 110 is an example of a first integrated circuit, and the protection IC 120 is an example of a second integrated circuit.

The battery protection module 100 has external terminals B+, B−, P+, P−, E1, and E2. The external terminals B+ and P+ are examples of a first external terminal and a second external terminal, respectively. The external terminals E1 and E2 are examples of a third external terminal and a fourth external terminal each configured to be entered by a signal from or output a signal to the outside. The external terminal B+ is connected to the positive electrode of the secondary battery 300, and the external terminal B− is connected to the negative electrode of the secondary battery 300.

The external terminals P+ and P− are connected to a power terminal and a ground terminal of an electronic device (not shown), respectively. The external terminals P+ and P− may be connected to a power terminal and a ground terminal of a charger (not shown), respectively. The charger may be connected to the battery pack 200 via an electronic device. The external terminal P+ outputs a high voltage appearing at the positive electrode of the secondary battery 300 to the outside. The external terminal P-outputs a low voltage appearing at the negative electrode of the secondary battery 300 to the outside. The secondary battery 300 outputs a maximum of 4.2 V when it has been fully charged, which is however non-limiting.

For example, an electronic device connected to the battery pack 200 is a portable device, such as a mobile phone, a smartphone, a tablet, an earphone, and the like. The electronic device is not limited to a portable device as long as it is a device configured to be connected to the battery pack 200 to become operable by the power of the secondary battery 300.

The resistor R1 and the transistors TR1 and TR2 are an example of a third switch connected in series between the external terminal B+ and the external terminal P+. The resistor R2 and the capacitor C1 are connected in series between the external terminal B+ and the external terminal B−. The external terminal B− is connected to the external terminal P−. The capacitors C2 and C3 are connected in series between the source of the transistor TR1 and the source of the transistor TR2. The capacitor C4 is connected between the external terminal P+ and the external terminal P−.

The control IC 110 has power source terminals VDD1 and REG, a ground terminal GND1, a terminal BAT, a charge control terminal COUT, a discharge control terminal DOUT, and terminals V+, S1, and S2. The protection IC 120 has a power source terminal VDD2, a ground terminal GND2, and terminals CH1A, CH2A, CH3A, CH1B, CH2B, and CH3B. The power source terminal REG and the terminal V+are examples of a first power source terminal and a third voltage terminal, respectively. The terminals S1 and S2 are examples of a first signal terminal and a fourth signal terminal each configured to be entered by or output a signal. The power source terminal VDD2 and the terminals CH1A, CH2A, CH3A, CH1B, CH2B, and CH3B are examples of a second power source terminal, a second voltage terminal, a third signal terminal, a sixth signal terminal, a first voltage terminal, a second signal terminal, and a fifth signal terminal, respectively.

The protection IC 120 includes an anti-low voltage protection circuit UVP (Under Voltage Protection), a mode control circuit MODE, resistors R3 and R4, switches SW1 and SW2, an anti-over voltage protection circuit OVP (Over Voltage Protection), drivers DRV1, DRV2, and DRV3, and transistors TR3, TR4, and TR5. The resistors R3 and R4 are examples of a first resistor and a second resistor, respectively. The switches SW1 and SW2 are examples of a fourth switch and a fifth switch, respectively. The transistors TR3, TR4, and TR5 are examples of a second switch, a first switch, and a sixth switch, respectively.

In the control IC 110, the power source terminal VDD1 is connected to the external terminal B+ via the resistor R2 and connected to the external terminal B-via the capacitor C1. That is, the resistor R2 and the capacitor C1 are connected in series between the external terminals B+ and B− via the connection node of the power source terminal VDD1. The ground terminal GND1 is connected to the external terminals B− and P−. The power source terminal REG is connected to the power source terminal VDD2 of the protection IC 120. The terminal BAT is connected to the external terminal B+ via the resistor R1. The charge control terminal COUT is connected to the gate of the transistor TR1, and the discharge control terminal DOUT is connected to the gate of the transistor TR2. The terminal V+ is connected to the terminal CH1A of the protection IC 120. The terminal S1 is connected to the terminal CH2A of the protection IC 120, and the terminal S2 is connected to the terminal CH3A of the protection IC 120.

The transistors TR1 and TR2 are, for example, N-channel Metal Oxide Semiconductor Field Effect Transistors (MOSFETs) and function as switches. The transistor TR1 has a parasitic diode DD, and the transistor TR2 has a parasitic diode CD. The anode of the parasitic diode DD is connected to the source of the transistor TR1, and the cathode thereof is connected to the drain of the transistor TR1. The anode of the parasitic diode CD is connected to the source of the transistor TR2, and the cathode thereof is connected to the drain of the transistor TR2.

The control IC 110 outputs a charge control signal COUT for controlling electrical conduction/shutoff between the source and the drain of the transistor TR1 to the gate of the transistor TR1. The transistor TR1 is in electrical conduction while receiving the charge control signal COUT of a high level, and is shut off while receiving the charge control signal COUT of a low level. The control IC 110 also outputs a discharge control signal DOUT for controlling electrical conduction/shutoff of the transistor TR2 to the gate of transistor TR2. The transistor TR2 is in electrical conduction while receiving the discharge control signal DOUT of a high level, and is shut off while receiving the discharge control signal DOUT of a low level. Hereinafter, electrical conduction and shutoff between the source and the drain of the transistors are referred to as ON and OFF, respectively.

While the transistor TR1 is ON and the transistor TR2 is OFF, a charge path from the external terminal P+ side to the positive electrode side of the secondary battery 300 is formed by the parasitic diode CD. On the other hand, while the transistor TR1 is OFF and the transistor TR2 is ON, a discharge path from the positive electrode side of secondary battery 300 to the external terminal P+ side is formed by the parasitic diode DD.

When the secondary battery 300 is being charged, the control IC 110 monitors the voltage of the external terminal P+ received at the terminal V+, and when detecting that the voltage of the external terminal P+ is higher than an overcharge detection voltage, turns OFF the transistor TR1 to protect the secondary battery 300 from a charge abnormality, such as an overcharge and the like. That is, also when the voltage of the external terminal P+ is supplied to the terminal V+ of the control IC 110 via the protection IC 120, the control IC 110 can turn off the transistor TR1 in response to detecting an overvoltage of the external terminal P+, thereby protecting the secondary battery 300 from an overvoltage.

When the secondary battery 300 is being discharged, the control IC 110 monitors the voltage received at the terminal BAT, and when detecting that the voltage is lower than an overdischarge detection voltage, turns OFF the transistor TR2 to protect the secondary battery 300 from a discharge abnormality, such as an overdischarge and the like.

The control IC 110 operates by receiving a power source voltage from the secondary battery 300 and a ground voltage at the power source terminal VDD1 and the ground terminal GND1. The control IC 110 generates a power source voltage VDD2 from the power source voltage VDD1 by a built-in regulator (not shown), and supplies the generated power source voltage VDD2 to the power source terminal VDD2 of the protection IC 120 via the power source terminal REG. For example, the value of the power source voltage VDD2 may be the same as the value of the power source voltage VDD1 or may be lower than the power source voltage VDD1. When the power source voltage VDD1 becomes lower than a predetermined value, the power source voltage VDD2 decreases following the decrease in the power source voltage VDD1.

The terminals S1 and S2 are electrically connected to the external terminals E1 and E2, respectively, via the protection IC 120. For example, the external terminals E1 and E2 receive sensor data detected by various sensors mounted on an electronic device while the electronic device is connected to the battery protection module 100. For example, the various sensors are a temperature sensor for detecting the temperature of the electronic device, a pressure sensor for detecting expansion of the electronic device, and the like. When the sensor data received at the terminals S1 and S2 indicates an abnormality, the control IC 110 turns OFF the transistors TR1 and TR2 and stops charging and discharging the secondary battery 300. For example, sensor data is transmitted using an I2C interface, and the terminal S1 is a clock terminal and the terminal S2 is a data terminal.

The control IC 110 may detect the state (a remaining capacity, a fully charged state) of the secondary battery 300 based on the voltage received at the terminal BAT when the secondary battery 300 is being discharged or charged. The control IC 110 transmits the detected state to the charger via the terminals S1 and S2, the protection IC 120, and the external terminals E1 and E2. Upon receiving the state of the secondary battery 300, the charger transmits an instruction for charging the secondary battery 300 or an instruction for stopping charging the secondary battery 300 to the terminals S1 and S2 of the control IC 110 via the external terminals E1 and E2 and the protection IC 120. The control IC 110 controls the transistors TR1 and TR2 in accordance with the received instruction, and starts charging the secondary battery 300 or stops charging the secondary battery 300.

The protection IC 120 operates by the power source voltage VDD2 supplied from the control IC 110 or a voltage CH1B received at the terminal CH1B, and by the ground voltage received at the ground terminal GND2. In the protection IC 120, the terminal CH1A is connected to the terminal V+ of the control IC 110, the terminal CH2A is connected to the terminal S1 of the control IC 110, and the terminal CH3A is connected to the terminal S2 of the control IC 110. The terminal CH1B is connected to the external terminal P+ , the terminal CH2B is connected to the external terminal E1, and the terminal CH3B is connected to the external terminal E2. The ground terminal GND2 is connected to the external terminal P−and the external terminal B−. The capacitor C4 is connected between the external terminals P+ and P−.

For example, the transistors TR3, TR4, and TR5 are N-channel MOSFETs and function as switches. The transistor TR3 is positioned between the terminals CH1A and CH1B and operates by receiving a control signal from the driver DRV1 at the gate thereof. The transistor TR4 is positioned between the terminals CH2A and CH2B and operates by receiving a control signal from the driver DRV2 at the gate thereof. The transistor TR5 is positioned between the terminals CH3A and CH3B and operates by receiving a control signal from the driver DRV3 at the gate thereof.

For example, the switches SW1 and SW2 may be transistors, such as MOSFETs and the like. The switches SW1 and SW2 are switched ON exclusively from each other by a switch control circuit (not shown) and supply the power source voltage VDD2 or the voltage CH1B as an internal power source voltage IVDD to an internal power source line IVDD in the protection IC 120. The internal power source voltage IVDD is supplied to the internal circuit of the protection IC 120. Thus, the power source voltage VDD2 and the voltage CH1B are used as the operating power sources of the protection IC 120. The protection IC 120 may include a regulator that converts the voltages of the power source line VDD2 and the terminal CH1B received via the switches SW1 and SW2 to the internal power source voltage IVDD.

By operating the switches SW1 and SW2 exclusively from each other, it is possible to inhibit a shoot-through current between the terminal CH1B and the power source terminal VDD2 due to the switches SW1 and SW2 being switched ON simultaneously. As a result, damage to the control IC 110 or the protection IC 120 due to the shoot-through current can be inhibited.

Even when the switches SW1 and SW2 are temporarily switched ON simultaneously, the resistor R3 positioned between the power source terminal VDD2 and the switch SW1 and the resistor R4 positioned between the terminal CH1B and the switch SW2 can mitigate the shoot-through current flowing between the power source line VDD2 and the terminal CH1B. Thus, even in a case of implementing the exclusive switching of the switches SW1 and SW2 between ON (electrical conduction) and OFF (shutoff) by one control signal, it is possible to tolerate the switches SW1 and SW2 being switched ON simultaneously temporarily when switching between the switches SW1 and SW2. This can simplify the configuration of the circuit for controlling the switching of the switches SW1 and SW2, and can reduce the power consumption of the protection IC 120. As a result, the cost and the power consumption of the battery protection module 100 can be reduced.

For example, the protection IC 120 performs control for supplying the internal power source line IVDD with the voltage received at the terminal CH1B in priority to the power source voltage VDD2 received at the power source terminal VDD2. The protection IC 120 switches ON only the switch SW2, when the charger is connected to the battery protection module 100, the transistor TR1 is turned ON, and the secondary battery 300 is being charged. Moreover, the protection IC 120 switches ON only the switch SW2, when the charger is removed from the battery protection module 100, the transistor TR2 is turned ON, and the secondary battery 300 is being discharged.

On the other hand, when the charger is removed from the battery protection module 100, the discharge voltage of the secondary battery 300 is lower than a predetermined voltage, and the transistors TR1 and TR2 are turned OFF, the external terminal P+ and the terminal CH1B are in a floating state. In this case, the protection IC 120 switches ON only the switch SW1.

As described above, the protection IC 120 switches ON only the switch SW2 when the voltage is supplied to the terminal CH1B, and switches ON only the switch SW1 when no voltage is supplied to the terminal CH1B. The battery protection module 100 can detect whether or not a charger or an electronic device is connected to the battery protection module 100 by monitoring the voltage of the external terminal P−.

When any of the voltages of the power source terminal VDD2 or the terminals CH1B, CH2B, and CH3B indicates an overvoltage, the anti-over voltage protection circuit OVP outputs a control signal TCNT2 for turning OFF the transistors TR3, TR4, and TR5 to the drivers DRV1, DRV2, and DRV3. Thus, even when the overvoltage from any of the external terminals P+, E1, and E2 is applied to the battery protection module 100, the overvoltage can be prevented from being applied to the control IC 110, and the control IC 110 can be prevented from being damaged.

When only the voltage of the terminal CH1B indicates an overvoltage, the anti-over voltage protection circuit OVP may output the control signal TCNT2 for turning OFF the transistor TR3 to only the driver DRV1. When only the voltage of the terminal CH2B indicates an overvoltage, the anti-over voltage protection circuit OVP may output the control signal TCNT2 for turning OFF the transistor TR4 to only the driver DRV2. Similarly, when only the voltage of the terminal CH3B indicates an overvoltage, the anti-over voltage protection circuit OVP may output the control signal TCNT2 for turning off the transistor TR5 to only the driver DRV3.

For example, overvoltages of the terminals CH1B, CH2B, and CH3B occur when a charge-built-up electronic device or a charge-built-up charger is connected to the battery protection module 100. The anti-over voltage protection circuit OVP may set an overvoltage determination voltage for an overvoltage to be determined by a voltage determination unit (not shown) provided in the anti-over voltage protection circuit OVP so as to detect an overvoltage when any of the voltages of the terminals CH1B, CH2B, and CH3B exceeds the rated voltages of the terminals V+, S1, and S2 of the control IC 110.

An overcharge detection voltage at which the transistor TR1 is turned OFF is lower than an overvoltage of the terminal CH1B at which the transistor TR3 of the protection IC 120 is turned OFF. Therefore, when the overcharge detection voltage is supplied to the terminal V+ of the control IC 110, the overcharge detection voltage does not cause the transistor TR3 to be turned OFF. Therefore, also when the protection IC 120 for protecting the control IC 110 is provided in the battery protection module 100, the control IC 110 can turn OFF the transistor TR1 in response to detecting an overvoltage of the external terminal P+, thereby protecting the secondary battery 300 from a charge abnormality, such as an overcharge and the like.

The protection IC 120 may include a circuit for protecting the protection IC 120 from overvoltages of the terminals CH1B, CH2B, and CH3B. For example, the protection IC 120 may include a diode (not shown), of which the anode is connected to the ground terminal, between the terminals CH1B, CH2B, and CH3B and the ground terminal GND2. The diode may be a parasitic diode.

For example, the rated voltages of the terminals V+, S1, and S2 of the control IC 110 are lower than the rated voltages of the terminals CH1B, CH2B, and CH3B of the protection IC 120. Therefore, when a voltage higher than the rated voltages of the terminals V+, S1, and S2 and lower than the rated voltages of the terminals CH1B, CH2B, and CH3B is applied to the control IC 110 from the outside of the battery protection module 100, the control IC 110 might be damaged.

However, in the present embodiment, the anti-over voltage protection circuit OVP turns OFF the transistors TR3, TR4, and TR5 when any of the voltages of the terminals CH1B, CH2B, and CH3B exceeds the rated voltages of the terminals V+, S1, and S2 of the control IC 110. Thus, even when the rated voltages of the terminals V+, S1, and S2 are lower than the rated voltages of the terminals CH1B, CH2B, and CH3B, the control IC 110 can be protected from overvoltages applied to the external terminals P+, E1, and E2.

When the power source voltage VDD2 received via the resistor R3 becomes lower than a preset voltage V1, the anti-low voltage protection circuit UVP outputs a control signal TCNT1 for turning OFF the transistors TR3, TR4, and TR5 to the drivers DRV1, DRV2, and DRV3, respectively. The voltage V1 is an example of a first voltage. The voltage V1 may be, for example, 1.7 V, which is however non-limiting. When the power source voltage VDD2 is equal to or higher than the voltage V1, the anti-low voltage protection circuit UVP outputs the control signal TCNT1 for turning ON the transistors TR3, TR4, and TR5 to the drivers DRV1, DRV2, and DRV3.

When one of the control signal TCNT1 or the control signal TCNT2 instructs OFF for the transistors TR3, TR4, and TR5, the drivers DRV1, DRV2, and DRV3 turn OFF the transistor transistors TR3, TR4, and TR5. When both of the control signals TCNT1 and TCNT2 instruct ON for the transistors TR3, TR4, and TR5, the drivers DRV1, DRV2, and DRV3 turn ON the transistors TR3, TR4, and TR5.

When the power source voltage VDD2 is lower than the voltage V1, the anti-low voltage protection circuit UVP outputs a low voltage signal LV of an active level indicating a low voltage abnormality of the power source voltage VDD2 to the mode control circuit MODE. When the power source voltage VDD2 is equal to or higher than the voltage V1, the anti-low voltage protection circuit UVP outputs the low voltage signal LV of an inactive level indicating that the power source voltage VDD2 is normal to the mode control circuit MODE.

When the mode control circuit MODE receives the low voltage signal LV of the active level indicating a low voltage abnormality of the power source voltage VDD2 from the anti-low voltage protection circuit UVP, the mode control circuit MODE shifts the operation mode of the protection IC 120 from a normal mode to an anti-low voltage protection mode. When the mode control circuit MODE receives the low voltage signal LV of the inactive level indicating that the power source voltage VDD2 is normal from the anti-low voltage protection circuit UVP during the anti-low voltage protection mode, the mode control circuit MODE deactivates the anti-low voltage protection mode and shifts the protection IC 120 to the normal mode.

When the mode control circuit MODE detects that the voltage CH1B received via the resistor R4 becomes lower than a voltage V2 during the anti-low voltage protection mode, the mode control circuit MODE outputs a standby mode signal STBY of an active level and shifts the protection IC 120 from the anti-low voltage protection mode to a standby mode. The mode control circuit MODE outputs the standby mode signal STBY of an inactive level during the normal mode and the anti-low voltage protection mode.

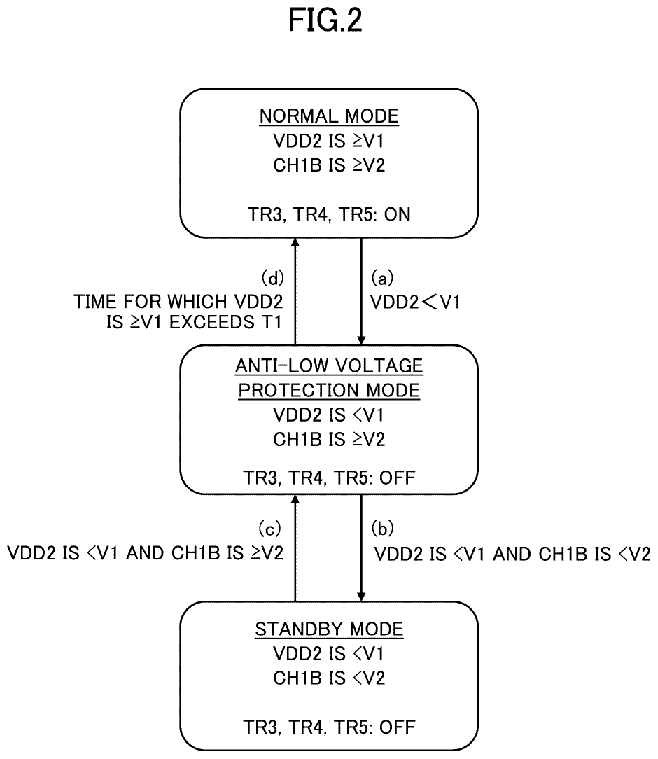

The voltage V2 is an example of a second voltage. The voltage V2 may be, for example, 1.0 V, and is lower than the voltage V1. The normal mode, the anti-low voltage protection mode, and the standby mode are examples of a first mode, a second mode, and a third mode, respectively. An example of the operation mode transition of the protection IC 120 is shown in FIG. 2.

For example, the anti-over voltage protection circuit OVP, the anti-low voltage protection circuit UVP, and the drivers DRV1, DRV2, and DRV3 operate in the normal mode and the anti-low voltage protection mode in both of which the standby mode signal STBY of the inactive level is output. Moreover, the anti-over voltage protection circuit OVP, the anti-low voltage protection circuit UVP, and the drivers DRV1, DRV2, and DRV3 stop operating in the standby mode in which the standby mode signal STBY of the active level is output. The mode control circuit MODE operates in the normal mode, the anti-low voltage protection mode, and the standby mode regardless of the level of the standby mode signal STBY.

Thus, the power consumption of the protection IC 120 in the standby mode can be significantly reduced compared with the power consumption of the protection IC 120 in the normal mode and the anti-low voltage protection mode. As a result, even when the protection IC 120 for protecting the control IC 110 from abnormally high voltages applied to the external terminals P+, E1, and E2 is mounted on the battery protection module 100, the power consumption of the battery protection module 100 can be inhibited from increasing. In particular, when the remaining capacity of the secondary battery 300 is low, being able to reduce the power consumption of the protection IC 120 has a great effect.

### Example of Operation Mode Transition of Protection IC

FIG. 2 is a state transition diagram showing an example of operation mode transition of the protection IC 120 by the mode control circuit MODE of FIG. 1. As described above, the operation mode of the protection IC 120 is any of the normal mode, the anti-low voltage protection mode, or the standby mode depending on the power source voltage VDD2 and the voltage of the terminal CH1B. In the normal mode, the transistors TR3, TR4, and TR5 are turned ON, whereas in the anti-low voltage protection mode and standby mode, the transistors TR3, TR4, and TR5 are turned OFF.

When the power source voltage VDD2 becomes lower than the voltage V1 during the normal mode in which the power source line VDD2 is at equal to or higher than the voltage V1 and the voltage of the terminal CH1B is equal to or higher than the voltage V2, the protection IC 120 turns OFF the transistors TR3, TR4, and TR5 that are currently ON, deactivates the normal mode, and shifts to the anti-low voltage protection mode (FIG. 2, (a)).

When the power source voltage VDD2 is lower than the voltage V1, the power source voltage VDD1 supplied from the secondary battery 300 to the control IC 110 is also lower than the normal value. When the power source voltage VDD1 is lower than the normal value, the control IC 110 might not be able to correctly receive signals supplied to the terminals S1 and S2, and might not be able to output signals of correct logics from the terminals S1 and S2. That is, the control IC 110 might not be able to operate correctly.

When the control IC 110 might not be able to operate correctly, turning OFF the transistors TR4 and TR5 and stopping signal reception at the terminals S1 and S2 can inhibit malfunction of the protection IC 120. When the control IC 110 might not be able to operate correctly, turning OFF the transistors TR4 and TR5 and stopping signal transmission from the terminals S1 and S2 to the outside can inhibit malfunction of an electronic device or a charger that receives signals that would otherwise be transmitted.

When the voltage of the terminal CH1B becomes lower than the voltage V2 during the anti-low voltage protection mode in which the power source line VDD2 is at lower than the voltage V1 and the voltage of the terminal CH1B is equal to or higher than the voltage V2, the protection IC 120 deactivates the anti-low voltage protection mode and shifts to the standby mode while maintaining the OFF state of the transistors TR3, TR4, and TR5 (FIG. 2, (b)).

When the voltage of the terminal CH1B becomes equal to or higher than the voltage V2 during the standby mode in which the power source line VDD2 is lower than the voltage V1 and the voltage of the terminal CH1B is lower than the voltage V2, the protection IC 120 deactivates the standby mode and shifts to the anti-low voltage protection mode (FIG. 2, (c)). For example, when the voltage of the terminal CH1B becomes equal to or higher than 1 V following a charger being connected to the battery protection module 100 to start charging, the protection IC 120 returns to the anti-low voltage protection mode from the standby mode.

Since the secondary battery 300 has a large capacity, rising of the power source voltages VDD1 and VDD2 lags behind rising of the voltage of the terminal CH1B. Therefore, if the standby mode shifts directly to the normal mode when the voltage of the terminal CH1B becomes equal to or higher than 1 V, the control IC 110 that is not receiving the normal power source voltage VDD1 might malfunction. However, by providing the anti-low voltage protection mode between the standby mode and the normal mode, it is possible to inhibit malfunction of the battery protection module 100.

When the time for which the power source line VDD2 is equal to or higher than the voltage V1 exceeds a time T1 in the anti-low voltage protection mode, the protection IC 120 turns ON the transistors TR3, TR4, and TR5 that have been turned OFF, deactivates the anti-low voltage protection mode, and shifts to the normal mode (FIG. 2, (d)). The time T1 is an example of a first time. The time T1 is set to be longer than the lasting period of chattering that occurs at the contact point to which the charger is connected when connected to the battery protection module 100, and is, for example, approximately 1 ms.

By setting the time T1, it is possible to prevent the operation mode of the protection IC 120 from being changed repeatedly. Moreover, it is possible to prevent the control IC 110 from starting operating before the power source voltages VDD1 and VDD2 rise to the normal value. As a result, it is possible to inhibit malfunction of the control IC 110 and the protection IC 120.

The anti-over voltage protection circuit OVP operates in the normal mode and turns OFF the transistors TR3, TR4, and TR5 when the overvoltages of the terminals CH1B, CH2B, and CH3B occur. The anti-over voltage protection circuit OVP stops operating in the anti-low voltage protection mode and the standby mode, and fixes the transistors TR3, TR4, and TR5 in the OFF state.

Therefore, also when overvoltages occur at the terminals CH1B, CH2B, and CH3B due to an electronic device or a charger being connected to the battery protection module 100 during the anti-low voltage protection mode and the standby mode, the overvoltages are not supplied to the control IC 110. In other words, by fixing the transistors TR3, TR4, and TR5 in the OFF state during the anti-low voltage protection mode and the standby mode in which the anti-overvoltage protection circuit OVP stops operating, it is possible to inhibit the control IC 110 from being damaged due to overvoltages that would occur at the terminals CH1B, CH2B, and CH3B during the anti-low voltage protection mode and the standby mode.

In the above-described embodiment shown in FIGS. 1 and 2, the protection IC 120 turns OFF the transistors TR3, TR4, and TR5 when any of the voltages of the power source terminal VDD2 or the terminals CH1B, CH2B, and CH3B indicates an overvoltage. Thus, even when the overvoltage from any of the external terminals P+, E1, and E2 is applied to the battery protection module 100, it is possible to inhibit the overvoltage from being applied to the control IC 110, and to inhibit the control IC 110 from being damaged. That is, in the battery protection module 100 mounted with the control IC 110 for controlling the charge/discharge of the secondary battery 300, the control IC 110 can be protected from abnormally high voltages applied to the external terminals P+, E1, and E2.

When the voltage of the external terminal P+ received at the terminal V+ becomes higher than the overcharge detection voltage while the secondary battery 300 is being charged, the control IC 110 turns OFF the transistor TR1. Thus, also when the voltage of the external terminal P+ is supplied to the terminal V+ of the control IC 110 via the protection IC 120, the secondary battery 300 can be protected from a charge abnormality, such as an overvoltage, an overcharge, and the like.

When the power source voltage VDD1 is lower than the normal value and the terminals S1 and S2 might not be able to correctly receive or transmit signals, the control IC 110 turns OFF the transistors TR4 and TR5 and stops signal reception at the terminals S1 and S2. This makes it possible to inhibit malfunction of the protection IC 120 that would receive signals, and to inhibit malfunction of an electronic device or a charger that would receive signals transmitted from the protection IC 120.

When the power source voltage VDD1 is lower than the normal value and the control IC 110 might not be able to correctly monitor the voltage supplied to the terminal V+, the protection IC 120 turns OFF the transistor TR3 and stops supplying the voltage to the terminal V+. Thus, it is possible to inhibit malfunction of the protection IC 120.

When the voltage of the terminal CH1B is lower than the voltage V2, the protection IC 120 shifts from the anti-low voltage protection mode to the standby mode in which the internal circuits of the protection IC 120 mostly stop operating. Thus, the power consumption of the protection IC 120 during the standby mode can be greatly reduced compared with the power consumption of the protection IC 120 during the normal mode and the anti-low voltage protection mode. As a result, even when the protection IC 120 for protecting the control IC 110 from an abnormally high voltage is mounted on the battery protection module 100, the power consumption of the battery protection module 100 can be inhibited from increasing due to the protection IC 120. In particular, when the remaining capacity of the secondary battery 300 is low, being able to reduce the power consumption of the protection IC 120 has a significant effect.

By shifting from the anti-low voltage protection mode to the normal mode when the time for which the power source line VDD2 is at equal to or higher than the voltage V1 exceeds the time T1, it is possible to inhibit the operation mode of the protection IC 120 from being changed repeatedly, and to inhibit the control IC 110 from starting operating before the power source voltages VDD1 and VDD2 rise to the normal value. As a result, it is possible to inhibit malfunction of the control IC 110 and the protection IC 120.

The anti-over voltage protection circuit OVP turns OFF the transistors TR3, TR4, and TR5 when any of the voltages of the terminals CH1B, CH2B, and CH3B exceeds the rated voltages of the terminals V+, S1, and S2 of the control IC 110. Thus, even when the rated voltages of the terminals V+, S1, and S2 are lower than the rated voltages of the terminals CH1B, CH2B, and CH3B, the control IC 110 can be protected from overvoltages applied to the external terminals P+, E1, and E2.

By operating the switches SW1 and SW2 exclusively from each other, it is possible to inhibit the shoot-through current between the terminal CH1B and the power source terminal VDD2 due to the switches SW1 and SW2 being simultaneously switched ON. As a result, it is possible to inhibit the control IC 110 or the protection IC 120 from being damaged due to the shoot-through current.

The protection IC 120 includes the resistor R3 positioned between the power source terminal VDD2 and the switch SW1, and the resistor R4 positioned between the terminal CH1B and the switch SW2. Thus, even when the switches SW1 and SW2 are temporarily switched ON simultaneously, it is possible to mitigate the shoot-through current flowing between the power source line VDD2 and the terminal CH1B. This makes it possible to implement the exclusive switching of the switches SW1 and SW2 between ON and OFF by one control signal, and to simplify the configuration of the circuit for controlling switching of the switches SW1 and SW2. As a result, it is possible to reduce the power consumption of the protection IC 120, and to reduce the power consumption of the battery protection module 100.

Although the present disclosure has been described based on the embodiments, the present disclosure is not limited to the requirements specified in the above embodiments. Modifications are applicable to these particulars to the extent that they do not impair the spirit of the present disclosure, and these particulars can be appropriately defined in accordance with the forms of application.

What is claimed is:

1. A semiconductor device, comprising:
a first external terminal connected to a secondary battery;
a second external terminal electrically connected to the first external terminal and configured to output a voltage received from the secondary battery to outside;
a third external terminal configured to be entered by a signal from or output a signal to outside;
a first integrated circuit configured to control charge/discharge of the secondary battery and including a first signal terminal configured to be entered by or output a signal; and
a second integrated circuit, the second integrated circuit including: a second signal terminal connected to the third external terminal; a third signal terminal connected to the first signal terminal; a first switch positioned between the second signal terminal and the third signal terminal; and an anti-overvoltage protection circuit configured to shut OFF the first switch when detecting an overvoltage of the second signal terminal.

2. The semiconductor device according to claim 1,
wherein the second integrated circuit includes: a first voltage terminal connected to the second external terminal; a second voltage terminal; and a second switch positioned between the first voltage terminal and the second voltage terminal,
wherein the first integrated circuit includes: a third voltage terminal electrically connected to the second voltage terminal and configured to be supplied with the voltage of the second external terminal via the second integrated circuit, and
wherein the anti-over voltage protection circuit further shuts OFF the second switch when an overvoltage of the first voltage terminal is detected.

3. The semiconductor device according to claim 2, further comprising:
a third switch positioned between the first external terminal and the second external terminal,
wherein the first integrated circuit shuts OFF the third switch in accordance with a value of the voltage of the second external terminal received at the third voltage terminal.

4. The semiconductor device according to claim 1,
wherein the first integrated circuit further includes: a first power source terminal configured to output a power source voltage generated based on the voltage supplied from the secondary battery,
wherein the second integrated circuit further includes a second power source terminal connected to the first power source terminal, and
wherein, when a voltage of the second power source terminal becomes lower than a first voltage, the second integrated circuit shuts OFF the first switch and shifts from a first mode to a second mode.

5. The semiconductor device according to claim 4,
wherein the second integrated circuit further includes: a first voltage terminal connected to the second external terminal; and
wherein, when a voltage of the first voltage terminal becomes lower than a second voltage, which is lower than the first voltage, during the second mode, the second integrated circuit shifts to a third mode, power consumption during which is lower than power consumption during the first mode and the second mode.

6. The semiconductor device according to claim 5,
wherein the second integrated circuit deactivates the third mode and shifts to the second mode when the voltage of the first voltage terminal becomes equal to or higher than the second voltage during the third mode.

7. The semiconductor device according to claim 4,
wherein the second integrated circuit brings the first switch that has been shut OFF into electrical conduction, deactivates the second mode, and shifts to the first mode when a time for which the voltage of the second power source terminal is equal to or higher than the first voltage exceeds a first time during the second mode.

8. The semiconductor device according to claim 1,
wherein a rated voltage of the first signal terminal of the first integrated circuit is lower than a rated voltage of the second signal terminal of the second integrated circuit, and
wherein the anti-over voltage protection circuit shuts OFF the first switch when a voltage of the second signal terminal exceeds the rated voltage of the first signal terminal.

9. The semiconductor device according to claim 5,
wherein the second integrated circuit includes: a first resistor and a fourth switch connected in series between the second power source terminal and an internal power source line; and a second resistor and a fifth switch connected in series between the first voltage terminal and the internal power source line, and
wherein the fourth switch and the fifth switch are brought into electrical conduction exclusively from each other, to supply the internal power source line with a voltage supplied from the first integrated circuit to the second power source terminal or with the voltage supplied from the second external terminal to the first voltage terminal.

10. The semiconductor device according to claim 1, further comprising:
a fourth external terminal configured to be entered by or output a signal,
wherein the first integrated circuit includes a fourth signal terminal configured to be entered by or output a signal,
wherein the second integrated circuit includes a fifth signal terminal connected to the fourth external terminal; a sixth signal terminal connected to the fourth signal terminal; and a sixth switch positioned between the fifth signal terminal and the sixth signal terminal, and
wherein the anti-over voltage protection circuit further shuts OFF the sixth switch when detecting an overvoltage of the fourth external terminal connected to the fifth signal terminal.

11. The semiconductor device according to claim 10,
wherein the first integrated circuit further includes a first power source terminal configured to output a power source voltage generated based on the voltage supplied from the secondary battery,
wherein the second integrated circuit further includes a second power source terminal connected to the first power source terminal, and
wherein when a voltage of the second power source terminal becomes lower than a first voltage, the second integrated circuit shuts OFF the first switch and the sixth switch, and shifts from a first mode to a second mode.

12. The semiconductor device according to claim 11,
wherein the second integrated circuit further includes a first voltage terminal connected to the second external terminal, and
wherein when a voltage of the first voltage terminal becomes lower than a second voltage, which is lower than the first voltage, during the second mode, the second integrated circuit shifts to a third mode, power consumption during which is lower than power consumption during the first mode and the second mode.

13. The semiconductor device according to claim 12,
wherein the second integrated circuit deactivates the third mode and shifts to the second mode when the voltage of the first voltage terminal becomes equal to or higher than the second voltage during the third mode.

14. The semiconductor device according to claim 13,
wherein the second integrated circuit brings the first switch and the sixth switch that have been shut OFF into electrical conduction, deactivates the second mode, and shifts to the first mode when a time for which the voltage of the second power source terminal is equal to or higher than the first voltage exceeds a first time during the second mode.
